(19) United States
(12) Patent Application Publication
(10) Pub. No.: US 2004/0215477 A1
(43) Pub. Date: Oct. 28, 2004

(54) Methods and systems for providing consumer services including coin-counting and digital image printing

(76) Inventors: Douglas A. Martin, Woodinville, WA (US); Peter Rowan, Seattle, WA (US); Brent Spraker, Seattle, WA (US)

Correspondence Address: PERKINS COIE LLP, PATENT-SEA, P.O. BOX 1247, SEATTLE, WA, 98111-1247, US

(21) Appl. No.: 10/734,615

(22) Filed: Dec. 12, 2003

Related U.S. Application Data
(60) Provisional application No. 60/433,133, filed on Dec. 12, 2002.

(51) Int. Cl. G06F 17/60

(52) U.S. Cl. 705/1

(57) ABSTRACT

Methods and systems are disclosed for providing consumer services such as coin-counting and digital image processing. In one embodiment, a kiosk can include a coin-counting apparatus and a digital image portion. The coin-counting apparatus can include a coin input region configured to receive a plurality of randomly oriented coins. The coin-counting apparatus can further include a coin counter to count the coins and arrive at a total of the coins. In one embodiment, a voucher can be dispensed that is redeemable for at least one of cash and merchandise. In another embodiment, the digital image portion of the kiosk can include a digital media input portion configured to receive digital media containing digital images, and a display screen for viewing at least one of the received digital images.

### CROSS-REFERENCE TO RELATED APPLICATION

This application relates to and claims the benefit of U.S. Provisional Patent Application No. 60/433,133 filed Dec. 12, 2002, which is incorporated herein by reference in its entirety.

### TECHNICAL FIELD

The following disclosure relates generally to methods and systems for providing consumer services such as coin-counting and digital image printing.

### BACKGROUND

Digital cameras are gaining in popularity. Approximately 14% of U.S. households had a digital camera at the end of 2001, and the number is expected to grow to 22% by the end of 2002. By the end of 2006, approximately half of all households in the U.S. are expected to have digital cameras.

Currently, digital camera owners only print approximately 2% of their digital photographs. This relatively low percentage is due, at least in part, to the expensive and time-consuming nature of current printing options. These options include printing the digital images at home on a suitable printer or uploading the images to an online photo finisher.

A variety of machines dispense products in exchange for money received from customers. Such machines include, for example, stamp dispensing machines, food product dispensing machines, and the like. In addition, other machines count random coins received from customers and distribute redeemable vouchers to the customers in return for the coins. One such coin-counting machine is disclosed in U.S. Pat. No. 5,620,079 to Molbak, which is incorporated herein in its entirety by reference. In one embodiment, the machine described in the '079 Molbak patent dispenses a voucher to the customer that can be redeemed at a point-of-sale (POS) in a retail outlet where the machine is located. A cashier at the POS pays the redemption value of the voucher when presented by the customer, either in exchange for purchased products or as cash.

### BRIEF DESCRIPTION OF THE DRAWINGS

FIG. 1 is an isometric view of an apparatus for counting coins and for viewing, selecting, and/or ordering prints of digital images, configured in accordance with an embodiment of the invention.

FIG. 2 is an elevation view of a digital image portion of the apparatus of FIG. 1 configured in accordance with an embodiment of the invention.

FIG. 3 is an elevational view of the exterior of a coin exchange apparatus according to one embodiment of the invention.

FIG. 4 is a block diagram showing major systems of an apparatus according to an embodiment of the invention.

FIG. 5 is an elevational view of the apparatus according to an embodiment of the invention with doors in the open position showing a number of the interior components.

FIG. 6 is a flow diagram depicting a procedure for counting and recording results, according to an embodiment of the invention.

### DETAILED DESCRIPTION

This application incorporates the following U.S. patents by reference: U.S. Pat. No. 5,620,079; U.S. Pat. No. 5,746,299; U.S. Pat. No. 6,047,808; U.S. Pat. No. 5,988,348; U.S. Pat. No. 6,196,371; U.S. Pat. No. 6,116,402; U.S. Pat. No. 6,349,972; U.S. Pat. No. 6,484,863; and U.S. Pat. No. 5,909,793.

This application incorporates the following pending U.S. patent applications by reference: U.S. patent application Ser. No. 09/035,273, filed Mar. 9, 1998, entitled COIN COUNTER AND VOUCHER DISPENSING MACHINE AND METHOD, Attorney Docket No. 21382-8001US10; U.S. patent application Ser. No. 09/225,774, filed Jan. 4, 1999, entitled INTERNAL STORE COUNTING USING A COIN COUNTER AND COUPON DISPENSER, Attorney Docket No. 21382-8001 US11; U.S. patent application Ser. No. 09/450,824, filed November 29, 1999, entitled COIN COUNTER/SORTER AND COUPON/VOUCHER DISPENSING MACHINE AND METHOD, Attorney Docket No. 21382-8001US12; U.S. patent application Ser. No. 09/548,955, filed Apr. 12, 2000, entitled COIN COUNTER/SORTER AND COUPON/VOUCHER DISPENSING MACHINE AND METHOD, Attorney Docket No. 21382-8001US13; U.S. patent application Ser. No. 09/662,414, filed Sep. 14, 2000, entitled SYSTEM FOR VOUCHER OR TOKEN VERIFICATION.

The following disclosure describes methods and systems for viewing, selecting, and/or ordering prints of digital photographic images, and for conducting other transactions such as counting coins. Certain embodiments of the methods and systems are described in the context of computer-executable instructions performed on a general-purpose computer. For example, in one embodiment, these computer-executable instructions are stored on a computer-readable medium, such as a floppy disk or CD-ROM. In other embodiments, instructions are stored on a server computer system and accessed via a communications link or a computer network, such as the Internet, an intranet, or other network system. Because the basic structures and functions related to computer-readable routines and corresponding implementations are known, they have not been shown or described in detail here to avoid unnecessarily obscuring the described embodiments.

Although the following disclosure provides specific details for a thorough understanding of several embodiments, those of ordinary skill in the relevant art will understand that these embodiments may be practiced without some of the details provided. In other instances, it will be appreciated that the methods and systems described can include additional details without departing from the spirit or scope of the disclosed embodiments.

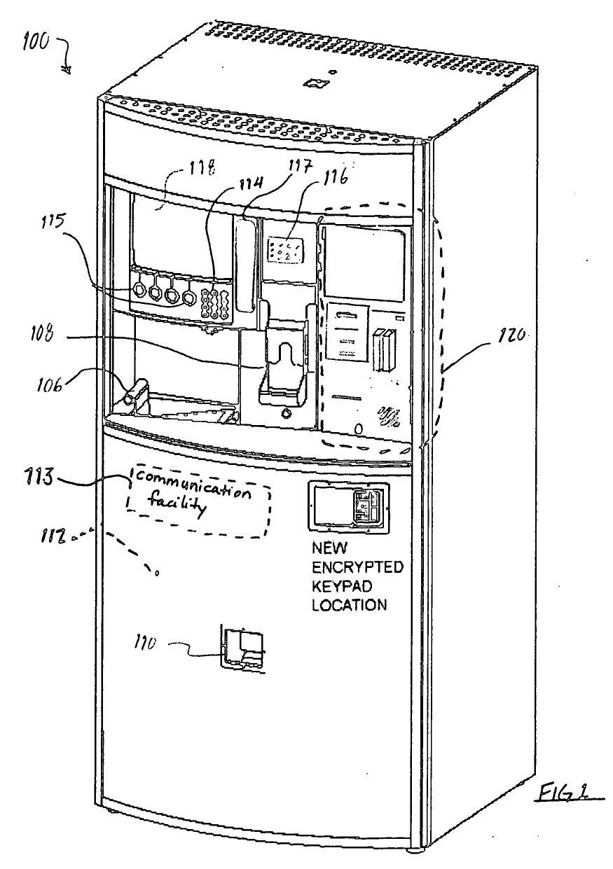

FIG. 1 is an isometric view of a kiosk or machine 100 for counting coins and for viewing, selecting, and/or ordering prints of digital photographic images in accordance with an embodiment. In one aspect of this embodiment, the machine 100 includes a coin input region or coin tray 106, a voucher dispensing slot 108, a coin return slot 110, a coin sorting/counting apparatus 112, and a communication facility 113. The machine 100 can further include various user interface devices such as a keypad 114, user-selection buttons 115, a speaker 116, a video screen or CRT 118, and a touch-screen 117. The foregoing features of the machine 100 can be at least generally similar in structure and function to their counterparts as described in detail in U.S. Pat. No. 5,620,079 (the “'079 patent”). Accordingly, in one aspect of this embodiment, a consumer can use the machine 100 to count a plurality of randomly oriented coins as described in the '079 patent.

In a further aspect of this embodiment described in greater detail below, the machine 100 also includes a digital image portion 120 having additional features for providing consumer services related to digital images. Such services can include, for example, providing consumers with means for uploading their digital images, viewing the images, and ordering selected prints. In the illustrated embodiment, the digital image portion 120 and the coin-counting features described above are combined in a single cabinet or enclosure. In other embodiments, however, the coin-counting features can be included in a first enclosure, and the digital image portion 120 can be included in a second enclosure positioned adjacent to, and/or attached to, the first enclosure.

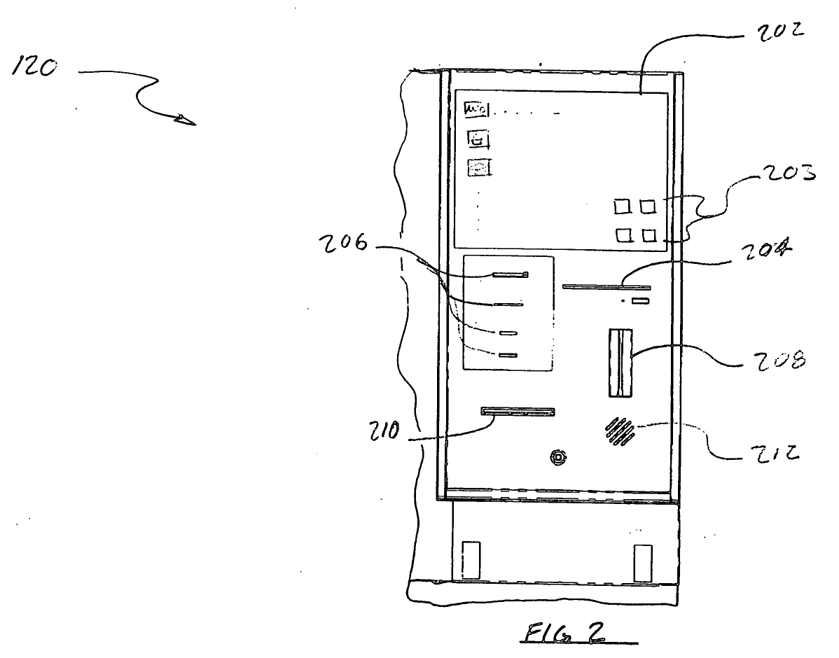

FIG. 2 is an elevation view of the digital image portion 120 of the machine 100 of FIG. 1 configured in accordance with an embodiment. In one aspect of this embodiment, the digital image portion 120 includes a number of user-interface devices such as a display screen 202 having a touch-screen portion 203, a card reader 208, a speaker 212, and a receipt outlet 210. The card reader 208 can be configured to read various forms of data storage media found on cards, such as conventional credit and debit cards. Such storage media can include magnetic strips, bar codes, smart chips, etc. The speaker 212 can be configured to provide audio content to a user, such as instructions for use of the image portion 120, or related advertising. The receipt outlet 210 can be configured to dispense a transaction receipt that includes various types of transactional information such as the date, the number of prints ordered, etc.

In another aspect of this embodiment, the digital image portion 120 includes a number of devices for reading digital media and uploading associated digital images to a processing facility (not shown). These devices can include a compact disk (CD) port 204 and a plurality of digital media ports 206. The digital media ports 206 can include a flash memory port, a smart card port, a compact flash port, and/or a secured digital port, among others.

While the various functionalities of the digital image portion 120 discussed above are representative of those that may be included with the machine 100 (FIG. 1), those of ordinary skill in the relevant art will understand that additional functionalities may be included without departing from the spirit or scope of the present disclosure. For example, in other embodiments, the digital image portion 120 can include other user-interfaces such as a keypad and a bill acceptor (not shown). The keypad can be utilized to enter various forms of information, such as user PIN numbers associated with various magnetic cards, such as bank cards, ATM cards and/or credit cards. The bill accepter can be used to input cash for print orders or other services. Furthermore, one or more of the foregoing functionalities may be omitted from the machine 100 depending on the particular application.

Referring to FIGS. 1 and 2 together, in one embodiment, a customer can order prints of selected digital images using the machine 100 as follows. First, the customer selects the appropriate buttons on the touch screen 203 to indicate his or her desire to upload digital images using the machine 100. The display screen 202 then prompts the customer to insert his or her digital media (e.g., a smart card, a flash card, CD, etc.) into one of the digital media ports 206 or the CD port 204, as appropriate. At least a portion of the images contained on the customer's digital media are then displayed for viewing by the customer on the display screen 202. The customer views the images and, using the touch screen 203, selects the images and print options desired for printing. Next, the customer completes the transaction by entering his or her mailing address and a suitable form of payment. In one embodiment, the customer can pay for the selected prints by swiping a debit or credit card through the card reader 208. In other embodiments, the customer can pay with cash (for example, by entering bills via a bill acceptor or coins via the coin input tray 106 of the coin counting machine 112). At completion of the transaction, the digital image portion 120 can dispense a transaction receipt to the customer via the receipt outlet 210.

Once the transaction is completed, the machine 100 uploads the selected images to a digital photo processing facility located remotely from the machine 100. In one embodiment, this upload can occur via the communication facility 113 over a computer network, such as the Internet or an intranet. The digital photo processing facility then develops the prints to the customer's order and mails the prints to the customer at the mailing address provided by the customer.

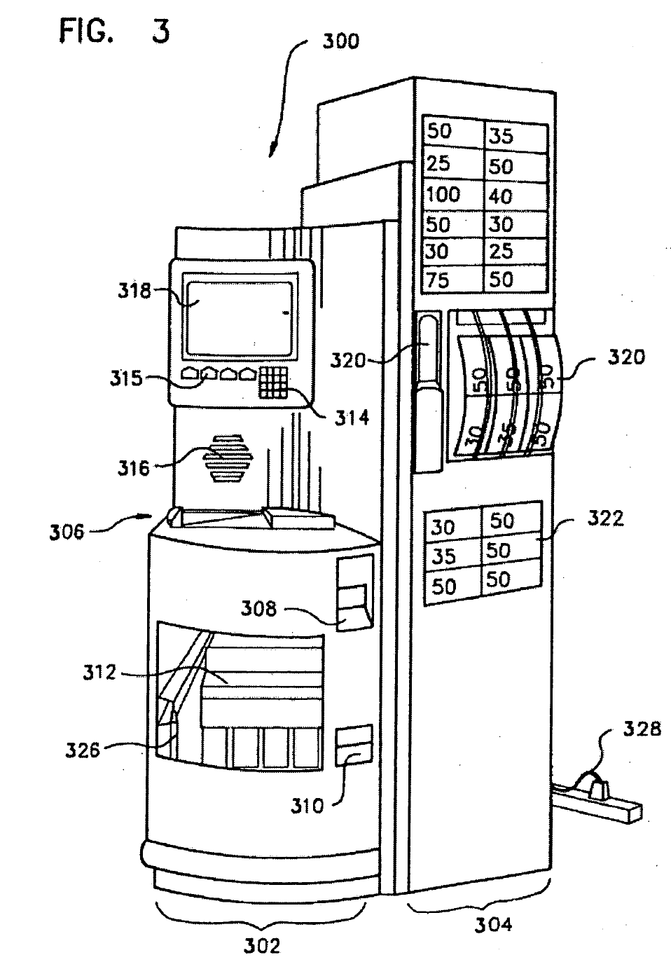

FIGS. 3-6 depict a coin counter/sorter and coupon/voucher dispensing device according to one embodiment of the invention. In the embodiment of FIG. 3, the device generally includes a coin counting/sorting portion 302 and a coupon dispensing portion 304. In one embodiment, these portions can operate independently in the sense that it is possible for the coin counting portion 302 to be counting one customer's coins while the dispensing portion 304 is dispensing coupons and/or vouchers to another customer. In the depicted embodiment, the coin counting portion 302 includes an input tray or hopper 306, a voucher dispensing slot 308, a coin return slot 310, a sorting/counting mechanism 312, and customer I/O devices, including a keyboard 314, additional keys 315, a speaker 316 and a video screen 318. The coupon dispensing portion includes an activating device 320 such as a button and coupon receptacle 322. The apparatus 300 can include various indicia, signs, displays, advertisement and the like on its external surfaces. In the depicted embodiment, portions of the counting/sorting mechanism are visible through a window 326. A power cord 328 provides power to the mechanism as described below.

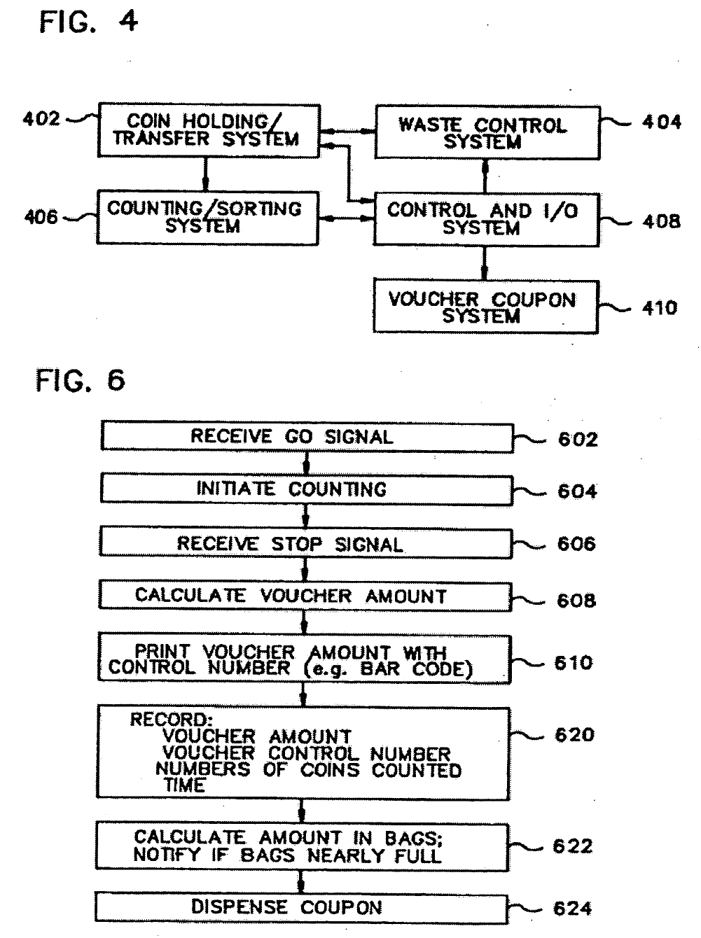

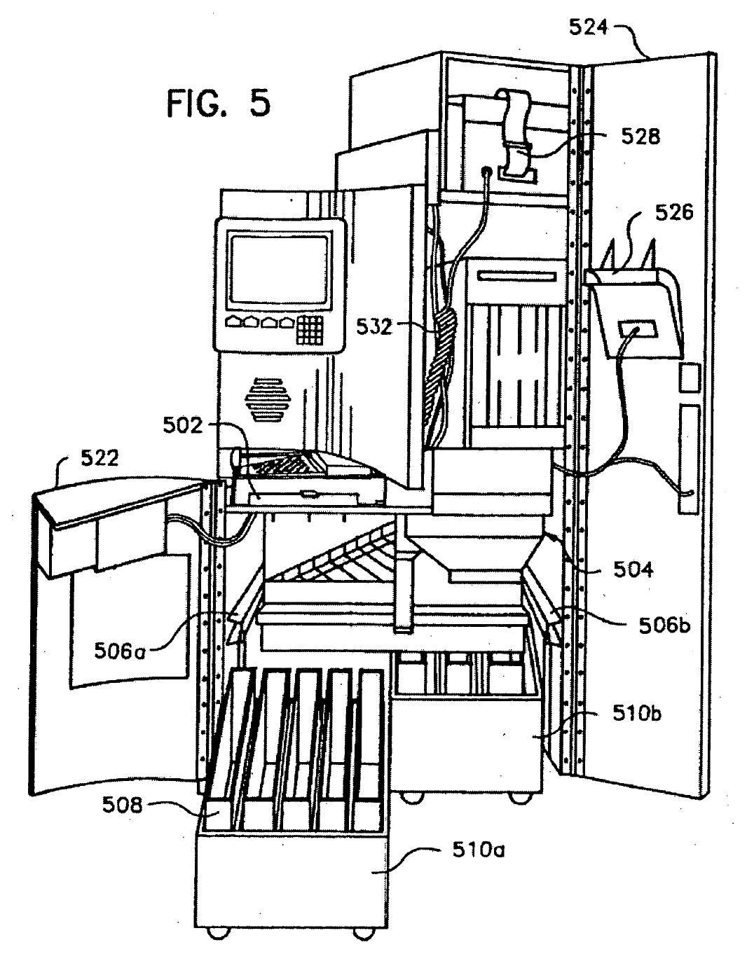

The depicted embodiment includes a number of interacting systems, as shown in FIG. 4, including the coin holding/transfer system 402, a waste control system 404, the counting/sorting system 406, a control and I/O system 408, and a voucher/coupon system 410. In the depicted embodiment, the coin-holding transfer system 402 includes the pivoting tray or hopper 306, a transfer tray configured to form a peaked coin input system and a solenoid and gate system. The waste control system 404, in one embodiment, includes perforated flow-through surfaces of the hopper 306, a slot and spout system in the transfer tray, a waste tray, a magnet system and a fan or blowing system, as described more thoroughly below. The counting/sorting system includes a coin hopper, a coin counter, coin sorter and coin collection bags as shown in FIG. 5. The voucher/coupon system includes one or more dispensers and/or printers for dispensing and/or printing vouchers or coupons in response to customer input, as depicted, for example, in FIG. 5. The control and I/O system is provided for coordinating the operation of the waste control system, the coin holding/transfer system, the counting/sorting system and the voucher/coupon system. Preferably, the control and I/O system receives and provides appropriate information and instructions to and from the user, and, in one embodiment, can be used for sending and receiving information to and from remote sites such as for receiving operating information (such as discount information, coupon information, updated software) and providing malfunction or diagnostic or statistical information.

FIG. 6 depicts the procedure for counting coins which also includes recording certain pertinent information. Preferably, the information is recorded by the computer on non-volatile media so that the information is not lost upon a power loss or a power-down. As described above, after a “begin” or “go” signal is received 602 the device initiates the counting 604 until such point as the stop signal is received 606, generally as described above. After the coins have been received and counted, the voucher amount is calculated 608. In one embodiment, the voucher amount is related to the total counted amount by being equal to the total amount less a transaction fee. In one embodiment, the transaction fee depends upon the numbers of various dominations, for example, the fee might be ten cents for each dollar of pennies counted and five cents for each dollar of other dominations counted. In another embodiment, the voucher amount is related to the total amount by being equal of the total amount. In still another embodiment, the voucher amount is related to the total amount by exceeding the total amount, e.g., to provide a premium for using the counting device.

After the voucher amount is calculated the voucher is printed 610. Preferably, the voucher includes a number of items of information in addition to the amount of the voucher. These additional items of information can include one or more of the location or other identifier of the machine at which the counting was done, the location or other identifier of the store or other place where the voucher may be exchanged for cash or merchandise, the time and date of the transaction, the total amount counted, the number of coins of each denomination counted, the number of rejected coins or other items, and a transaction control number. Preferably, the control number is unique, at least to the particular location and date or time. In one embodiment, the voucher is printed with a scannable code such as a bar code. This permits easy exchange of the voucher, e.g., by scanning the bar code e.g., at a grocery or other retail check out stand in the same way universal product code (UPC) bar codes are scanned.

The apparatus records, preferably using a computer and recording onto a non-volatile media, information regarding the transaction. In one embodiment, the information which is recorded includes the information noted above that can be included on the voucher, such as the voucher amount, a control number, numbers of coins counted and time of transaction 620.

Preferably, the apparatus also determines the amount that has been deposited in the various coin bags. This permits the apparatus to output a signal or notification when the bag capacity is nearly full, to enable armored car personnel or other personnel to retrieve the full bags and replace those with empty bags 622 as described more fully below. As noted above, the apparatus, in one embodiment, will also automatically dispense one or more coupons 624 at the conclusion of a counting transaction.

The printing of various information on the voucher 610 and the recording of various information about the transaction 620 serve a number of useful functions. Providing information on the voucher gives the user an extra opportunity to verify accuracy and/or acceptability of the count and, potentially, detect any malfunctions that may have occurred. The information is also useful to store personnel in verifying accuracy and authenticity of the voucher. Store personnel may be able to detect an inaccurate or unauthentic voucher if, for example, the voucher indicates a transaction time during which the store was not open, or indicates similar inconsistencies. Furthermore, store personnel can, if suspicious, check the information printed on the voucher against the information recorded in the device (as described more fully below) to further check authenticity.

The recording of information 620 is useful for a number of reasons. First, the information is useful in facilitating the removal of coin bags for deposit, e.g., in a bank, as described more fully below. The information is useful to store personnel in verifying particular transactions or detecting malfunctions. The information is useful to the counting machine operating company to verify amounts counted and amounts deposited in the bank and to help determine the source of errors if there is a discrepancy between amounts removed from machine and amounts deposited in the bank. For example, the recorded information is useful to both the operating company and the store personnel to diagnose malfunctions or to become aware of servicing or maintenance needs of the apparatus.

The above detailed descriptions of embodiments of the invention are not intended to be exhaustive or to limit the invention to the precise form disclosed above. While specific embodiments of, and examples for, the invention are described above for illustrative purposes, various modifications are possible within the scope of the invention. The following pages include additional details and examples of embodiments of the invention.

We claim:

1. A system for viewing, selecting and/or ordering prints of digital images, the system comprising:
a digital media input portion configured to receive one or more forms of digital media containing digital images;
a display screen for viewing at least one of the received digital images; and
a coin-counting apparatus configured to receive a plurality of coins and count the plurality of coins to determine a total.

2. The system of claim 1 wherein the coin-counting apparatus is configured to dispense a voucher for at least a portion of the total of the plurality of coins, and wherein the voucher is redeemable for at least one of cash and merchandize.

3. The system of claim 1 wherein the coin-counting apparatus includes a coin input region configured to receive a plurality of randomly oriented coins at least approximately simultaneously.

4. The system of claim 1 wherein at least a portion of the total of the plurality of coins can be selectively applied toward purchase of a print of at least one of the digital images.

5. The system of claim 1 wherein a first portion of the total of the plurality of coins can be applied toward purchase of a print of at least one of the digital images, and wherein a second portion of the total can be applied toward a voucher that is redeemable for at least one of cash and merchandize.

6. The system of claim 1, further comprising a kiosk positioned in retail location, wherein the coin-counting apparatus and the digital media input portion are part of the kiosk.

7. The system of claim 1, further comprising:
a coin bin configured to receive at least a portion of the plurality of coins after they have been counted; and
a communication facility configured to exchange information with a computer located remotely from the coin-counting apparatus, the information relating to status of the coin bin.

8. The system of claim 1, further comprising a communication facility configured to upload selected digital images to a digital photo processing facility located remotely from the system.

9. The system of claim 1, further comprising:
a user interface configured to receive at least a mailing address for a user; and
a communication facility configured to facilitate uploading of at least one of the received digital images to a remote digital photo processing facility for printing, wherein at least one print of the uploaded digital images is sent to the mailing address of the user.
